(19) United States
(12) Patent Application Publication
(10) Pub. No.: US 2016/0183269 A1
(43) Pub. Date: Jun. 23, 2016

(54) LSA BASED INTER CELL INTERFERENCE MITIGATION

(71) Applicant: Intel IP Corporation, Santa Clara, CA (US)

(72) Inventors: Biljana BADIC, Duesseldorf (DE); Markus Dominik MUECK, Neubiberg (DE)

(21) Appl. No.: 14/578,157

(22) Filed: Dec. 19, 2014

(51) Int. Cl. H04W 72/08; H04B 15/00; H04W 16/14

(52) U.S. Cl. CPC H04W 72/082; H04W 16/14; H04B 15/00

(57) ABSTRACT

Embodiments relate to a shared access interference mitigation entity apparatus for managing interference in a wireless network, the apparatus comprising processing circuitry arranged to receive interference information from wireless network equipment operative within the wireless network, receive shared access repository information on available shared access spectrum resources, and allocate shared access spectrum resources for use in inter cell interference mitigation to the wireless network equipment dependent upon the received interference information. Embodiments also relates to corresponding methods, and other wireless network apparatus such as UEs and eNBs.

### TECHNICAL FIELD

Embodiments described herein generally relate to wireless networks. Some embodiments relate generally to supporting use of licensed shared access (LSA) bands, or equivalents, to mitigate interference in the wireless network.

### BACKGROUND

Cellular operators for mobile communications are running out of dedicated frequency spectrum for use in radio access networks. A Licensed Shared Access (LSA) concept was developed by the Radio Spectrum Policy Group (RSPG) in Europe to help solve this problem. The LSA concept includes mechanisms for introducing shared spectrum based solutions. These solutions include mobile cellular operators having access to additional licensed spectrum from other primary users (e.g., public safety, government) that they normally would not get access to. The primary uses may be referred to in the art as incumbents.

There are general needs for improving shared spectrum-based solutions.

### BRIEF DESCRIPTION OF THE DRAWINGS

Embodiments described herein are illustrated, without limitation, by way of example, in the accompanying drawings:

FIG. 1 illustrates a radio access network system diagram using an LSA architecture;

FIG. 2 illustrates an embodiment of a radio access network system diagram using an LSA architecture with an LSA-Interference Management Entity in accordance with some embodiments;

FIG. 3 illustrates a first signalling diagram according to an embodiment;

FIG. 4 illustrates a second signalling diagram according to an embodiment;

FIGS. 5 to 18 illustrate a first to thirteenth exemplary spectrum assignments for cell users according to embodiments;

FIG. 19 illustrates a flow diagram of an embodiment of LSA based inter cell interference mitigation in accordance with the system of FIG. 2 in accordance with some embodiments;

FIG. 20 illustrates a functional block diagram of an embodiment of the LSA controller architecture in accordance with the system of FIG. 2 in accordance with some embodiments; and

FIG. 21 illustrates a functional block diagram of an embodiment of a UE for use with the LSA controller architecture in accordance with the system of FIG. 2 in accordance with some embodiments.

### DESCRIPTION OF EMBODIMENTS

The following examples are described with reference to the Long Term Evolution (LTE) standards, but may be equally applicable to any current or future wireless networking standards. LTE was originally designed for a frequency reuse of 1, i.e. every base station uses the whole system bandwidth for transmission and there is no frequency planning among cells to cope with interference from neighboring cells. Therefore, there is a high probability that a resource block scheduled to cell edge user, is also being transmitted by neighbor cell, resulting in high interference, eventually resulting in low throughput or call drops and in radio link failures.

Examples disclosed herein may provide a solution on how to enable the usage of LSA spectrum (or any other similar ‘shared access’ scheme) for Inter-Cell-Interference Management in a wireless network, such as an LTE network by using dynamically available (LSA) spectrum for Inter-Cell-Interference Mitigation for a limited geographic area and a limited period of time. Examples may provide a new LSA Interference Management Entity (LSA-IME), or differently-named but similarly functional entity, which is introduced for supporting LSA spectrum (i.e. shared access spectrum) assignment between i) usage for additional voice/data bandwidth and/or ii) usage for inter-cell-interference coordination. The herein described LSA-IME may be called other things, dependent on the particular standard in use, but the teachings of the present disclosure would equally apply. The present disclosure includes exemplary details of an approach to LSA that may be split into four major parts: the LSA Interference Management Entity (LSA-IME), a network-centric interference management system exploiting the LSA spectrum and LSA-IME, a terminal-centric interference management system exploiting LSA spectrum and LSA-IME, and a new spectrum assignment approach in cell-edge/center/middle areas using beneficial mixtures of the normal full access operator spectrum and the LSA spectrum resources. Any one or more of these parts may be implemented in a wireless network to achieve some or all of the advantages, such as dramatically reducing inter-cell-interference.

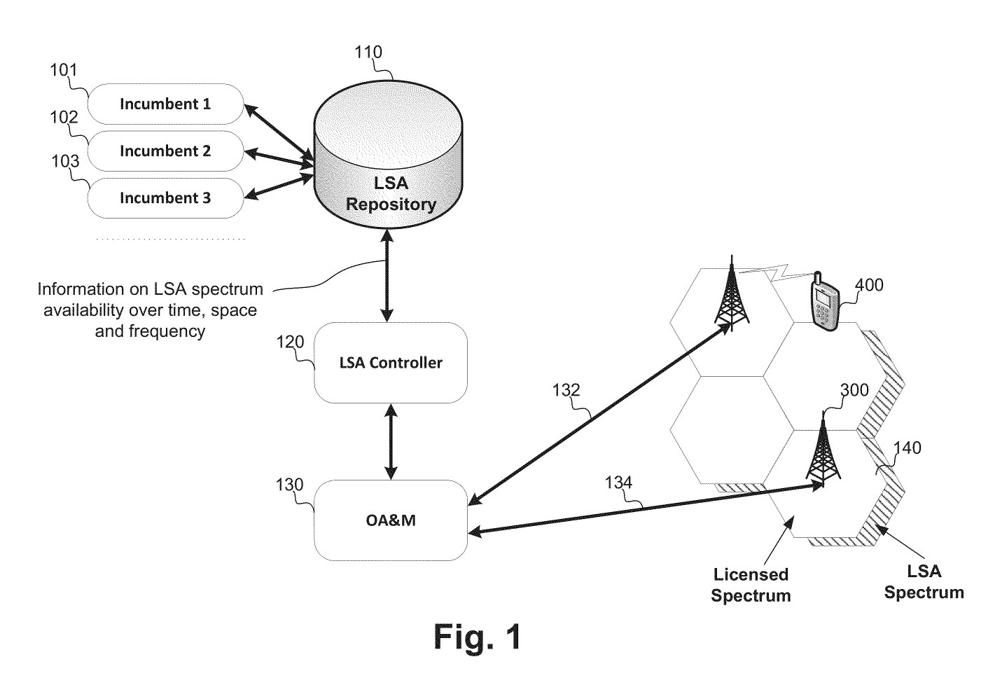

FIG. 1 illustrates a system diagram of an LSA architecture. In the current architecture, the flow of information is in one direction, from the incumbent to the LSA licensee or the cellular operator.

A plurality of incumbents 101-103 share access to an LSA repository 110. The LSA repository 110 provides a shared database of frequency spectrum.

An LSA controller 120 is coupled to the LSA repository 110 to control information on LSA spectrum availability over time, space, and frequency. The LSA controller 120 can check the repository 110 and messages from the incumbents 101-103 and take appropriate action.

An operation administration and maintenance (OA&M) block 130 is coupled between the LSA controller 120 and the network infrastructure. The OA&M block 130 handles management of the LSA licensed spectrum by translating information regarding spectrum availability into radio resource management commands from the LSA controller 120.

Spectrum sharing includes a bilateral agreement between the incumbent and the LSA licensee. The agreement outlines all the details of the spectrum that is to be shared. There can be different forms of the bilateral agreement outlining different levels of predictability. Examples of the bilateral agreements include, but are not limited to: fixed times, statistical availability of spectrum, and the right to reclaim the spectrum. An incumbent 101-103 may update the LSA Repository 110 regarding the availability of the particular spectrum to which it has licensing rights.

The LSA controller 120 may check the repository 110 and other messages from the incumbent 101-103 and take appropriate action. The controller 120 may periodically check the repository 110 and send appropriate messages to the LSA licensee and incumbent 101-103 if needed. For instance, if frequency spectrum becomes available, the LSA controller 120 may inform the LSA licensee about the availability. The LSA controller 120 may also send acknowledgements back to the incumbent 101-103 from the cellular operator. If there is a message by the incumbent to reclaim spectrum, the message is conveyed to the LSA licensee, for example over communication links 132, 134, to respective enhanced Node B (eNB) 300. Each eNB 300 may serve one or more UEs 400, located within one or more respective cells 140, using both licensed spectrum and LSA spectrum.

One problem with this LSA flow in FIG. 1 is that the LSA repository 110 is the only entity with direct interactions between the LSA system and incumbents 101-103. However, the LSA repository 110 is not designed for a point-to-point real-time information exchange between a specific LSA licensee and a specific incumbent 101-103. Rather, the LSA repository 110 is designed to provide generic availability information for a given LSA frequency band from an incumbent to all LSA licensees having a license agreement with the incumbent for the given frequency band. The LSA repository 110 is therefore unsuitable for handling the flow of confidential/sensitive data from one given LSA licensee to one concerned incumbent, or providing LSA resources for Inter Cell Interference Mitigation, and the attendant management and (re-)allocation processes involved.

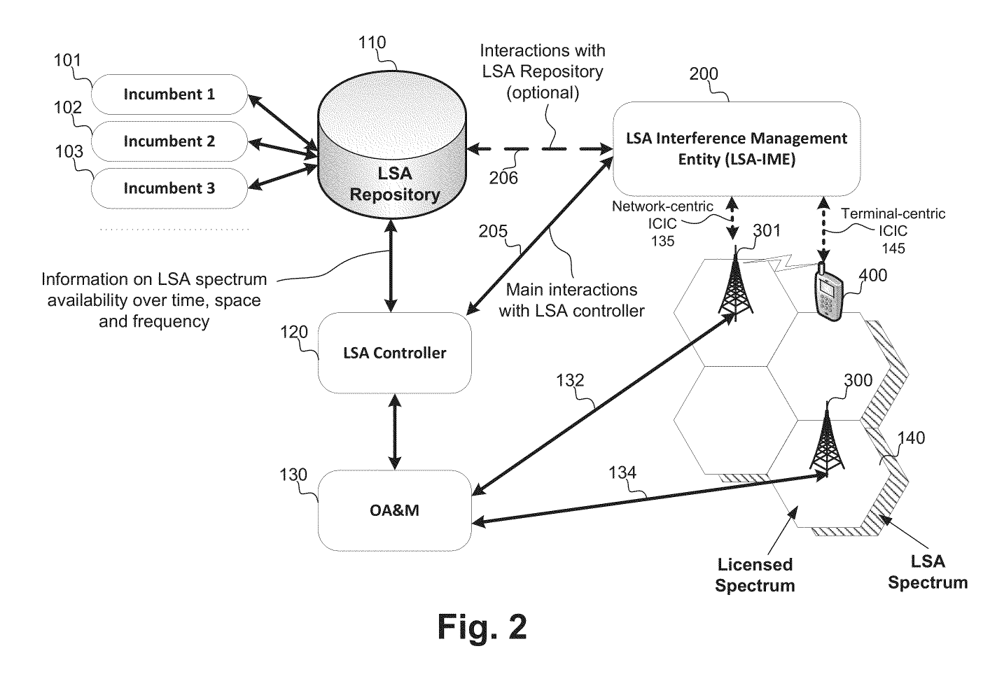

FIG. 2 illustrates an embodiment of a radio access network system diagram using an LSA architecture with the LSA-IME 200 according to examples. The system is predominantly the same or similar to the system of FIG. 1, but now further includes the LSA-IME 200 to control dynamic allocation (including re-allocation and/or release) of LSA resources, for example for Inter Cell Interference Coordination (ICIC).

The network includes a plurality of cellular base stations 300-301 (e.g., evolved node B (eNodeB, eNB)) for communicating with user equipment (UE) 400 within their cell boundaries. The bases stations 300-301 may define any one or more of cells, macrocells, picocells, and/or femtocells, or any other cell size in use in the wireless network.

The UE 400 may be multi-band devices in order to be able to take advantage of the LSA frequency spectrum. Thus the UE 400 may have the ability to operate not only in the licensed frequency spectrum but in any possible LSA spectrum (including any and all available LSA bands).

The plurality of incumbents 101-103 (e.g., primary spectrum users) share access to an LSA repository 110. The LSA repository 110 is a database that contains the relevant information on spectrum use by the incumbents in the spatial, frequency, and time domains. The LSA repository 110 may also include indications of incumbent identifications and communication protocols used by those incumbents. There may be one or more LSA repositories 110 per country. For example, there may be an LSA repository per operator in a geographical area. The LSA repository may be coupled to the LSA-IME, over communications links 206, optionally through a secure interface.

An LSA controller 120 is coupled to the LSA repository 110 to control information on LSA spectrum availability over space, frequency, and time. The LSA controller 120 can check the repository 110 and messages from the incumbents 101-103 and take appropriate action. The LSA controller 120 may compute LSA spectrum availability based on rules built upon LSA rights use and information on the incumbent's use provided by the LSA repository 110. The LSA controller 120 may be coupled to the LSA repository through a secure interface. The LSA controller 120 may interface with one or more LSA repositories 110 as well as with one or more LSA networks. The LSA controller 120 is coupled to and communicates directly with the LSA-IME 200, for example over LSA Controller to LSA-IME communication links 205. There may be one or more LSA controllers 120 per country.

An operation administration and maintenance (OA&M) apparatus 130 is coupled between the LSA controller 120 and the network infrastructure (e.g., base stations 300-301). The OA&M block 130 handles management of the LSA licensed spectrum by translating information regarding spectrum availability into radio resource management commands from the LSA controller 120. These commands may then be transmitted to the base stations 300, 301 in the LSA licensee's network. Based on this information, the base stations 300, 301 may then enable UEs, for example UE 400, to access the LSA spectrum or order the UE 400 to hand off seamlessly to other frequency bands as appropriate to LSA spectrum availability, quality of service (QoS) requirements, data rates, and/or data plans. Hand off can occur on only a portion of a UE/eNB (e.g. hand off of only a certain portion of the downlinks). Information from the OA&M block 130 enables the base stations 300-301 to tune to different channels or to power down.

A cellular operator's OA&M 130 may be responsible for ensuring that only the appropriate base stations 300, 301 are transmitting in the LSA spectrum and can access this information from the LSA controller 120 that collects the information relevant for the particular area, time, and incumbent from the LSA repository 110. UE 400 located in the area where the LSA spectrum is available may have access to the licensed spectrum (e.g. frequency band) and/or the LSA spectrum (e.g. frequency band). UE 400 located in an area where the LSA spectrum is not available has access only to the licensed spectrum.

The LSA-IME 200 is coupled between and communicates with the LSA controller 120, and optionally the LSA repository 110, eNBs (base stations) 300,301 and UEs 400. The links to the eNBs 300, 301 may provide network-centric ICIC 135, whilst the links to the UEs 400 may provide terminal-centric ICIC 145.

The LSA-IME 200 may provide a number of different services, including but not necessarily limited to:

The LSA-IME 200 may collect observations on interference events by network equipment (e.g., Base Stations, Cells, etc. 300, 301) and Mobile Devices (e.g., terminal devices, such as UEs 400, performing interference measurements). Based on the obtained measurements, the LSA-IME 200 can decide to allocate LSA spectrum for Inter-Cell-Interference-Mitigation. When the interference issues disappear (or are considerably reduced), the LSA-IME can decide to terminate the usage of LSA spectrum for Inter-Cell-Interference-Mitigation, and thereby release the LSA resources back to the pool for use elsewhere.

LSA-IME may use information from the LSA Repository 110 (either through direct access 206 to applicable LSA repository/ies 110 or through the LSA Controller 120 managing the actual access to the LSA repository, e.g. over communications links 205) in order to obtain knowledge on available LSA spectrum in a given geographic area and over a given time interval.

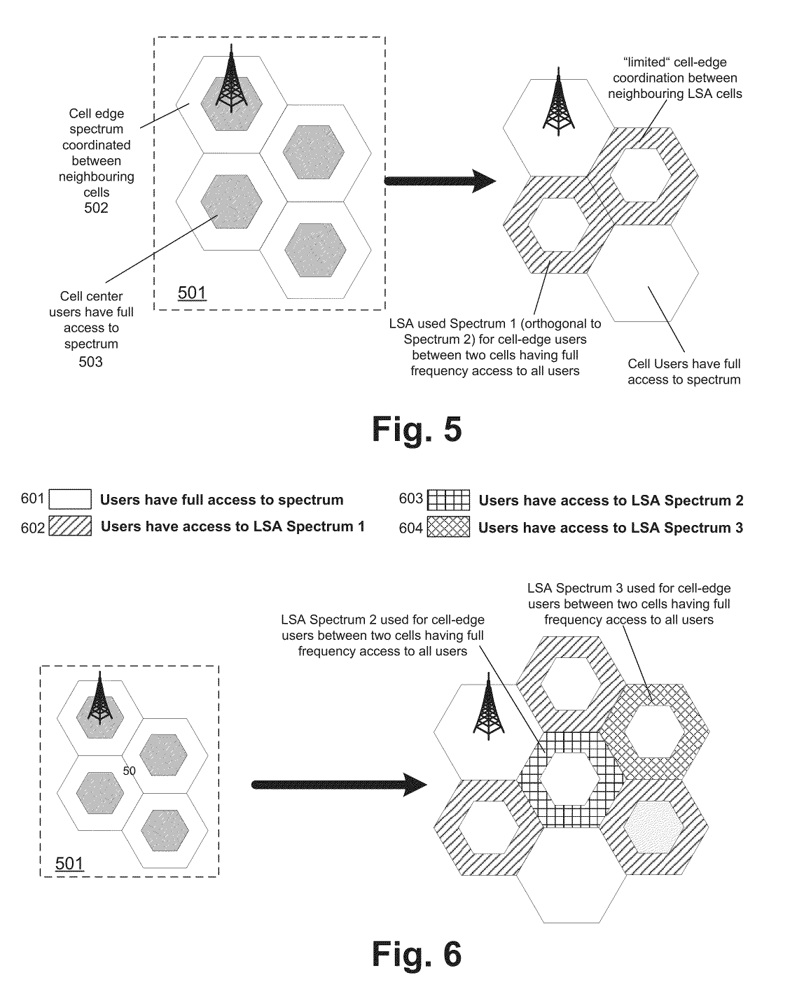

In a use case where LSA spectrum is available and offered by incumbents 101-103, but it is not yet allocated to any LSA licensee, the LSA-IME 200 may initiate the licensing process in order to have access to the spectrum for a target geographic area (for example, where a high level of inter-cell-interference is occurring) and for a target time interval. Once the LSA spectrum is available the LSA-IME 200 may reconfigure spectrum usage in cell edge areas, e.g. following the principles introduced in FIGS. 5 to 18, described below.

In a use case where the LSA spectrum is already granted to the concerned cellular operator, the LSA-IME 200 may decide to re-allocate LSA spectrum from voice/data traffic services use, to an inter-cell-interference mitigation usage instead, for any given geographic area and for any given time interval. In this case where the LSA spectrum is repurposed, the concerned voice/data traffic users (currently using the considered portion of the LSA spectrum) may need to be handed-off to another band or wireless resource (for example a licensed LTE band or an offloading to a band such as WiFi).

In various examples, the LSA-IME 200 may either be i) controlling LSA spectrum usage for a single cellular operator and therefore it may be part of the operator's network or ii) serving a number of different cellular operators able to access the LSA spectrum. In the single operator use case, the LSA-IME 200 may only deal with the (re)claiming/repurposing of LSA spectrum for a single operator. In the multiple operator use case, LSA-IME 200 may offer inter-operator LSA spectrum sharing for Inter-Cell-Interference Coordination.

In various examples, the LSA-IME 200 typically terminates the usage of LSA spectrum for Inter-Cell-Interference Mitigation when the interference situation is resolved, e.g., if the level of users has decreased substantially in the concerned geographic area, during the concerned period of time. The LSA spectrum based sharing agreement may then either be terminated or the LSA spectrum is repurposed again for voice/data traffic usage.

Examples also provide a Network Centric Interference Management system exploiting LSA spectrum and the LSA-IME 200 described above.

In the case of network centric interference management, the proposed LSA-IME 200 may use information provided to eNBs 300, 301, for example through existing X2 signaling specified by 3GPP. For example using:

The LTE Downlink: Relative Narrowband Transmit Power Indicator (RNTPI) sent to neighbor cells, where the RNTPI may contain 1 bit per physical resource block (PRB) indicating if the transmission power on that PRB will be greater than a given threshold.

The LTE Uplink: High Interference Indicator (HII) and Interference Overload Indicator (OI), where the 01 indicates physical layer measurements of the uplink average interference plus thermal noise for each PRB. HHI is similar to RNTP for the downlink, i.e. the eNB 300 informs through HHI its neighboring eNBs 301 that it will schedule uplink transmission by one or more cell-edge users in certain parts of the bandwidth and therefore high interference might occur in those frequency regions.

The eICIC: (IE) Invoke message from interfering cell, where the Invoke message indicates to the (e.g. pico) eNB 301 that it would like to receive Almost Blank Subframes (ABS) information from the macro eNB 301, potentially with more subframes configured with ABS. The Invoke message may be used between any sized eNB.

In the example signaling mechanism, observed interference may be exchanged between eNBs 300, 301 and the LSA-IME 200. With this information, the LSA-IME 200 may then take into account interference levels in different bands (for homogenous networks) and geographical regions (for HetNets) and assign LSA spectrum to users experiencing severe interference, e.g. cell-edge users.

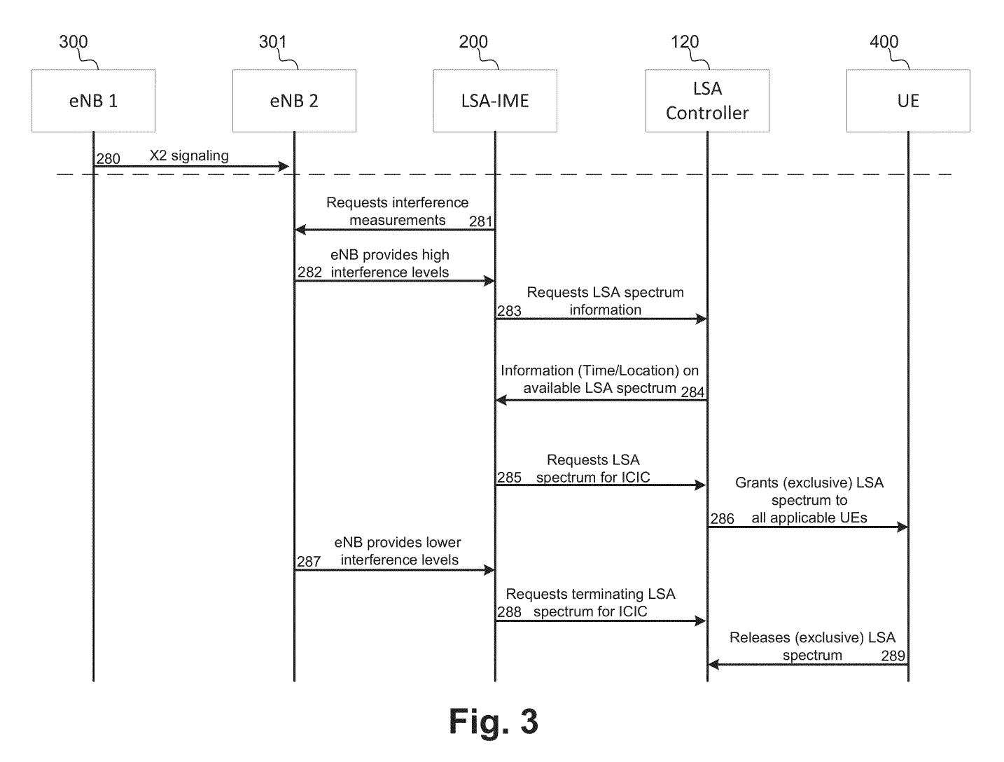

An example of an LTE Downlink Network Centric Interference Management signaling procedure is shown in FIG. 3. In this example, the X2 signaling 280 is sent from eNB1 300 to eNB2 301. The X2 signalling may contain a Load Information Message, which carries a pattern of subframes to be used at the macro cell. The dotted line in FIG. 3 is indicative that the X2 signalling is not necessarily causally linked to the remainder of the method (i.e. it can occur anyway/separately in time). The LSA-IME 200 requests interference measurements 281 from the eNB, such as eNB2 301. The eNB provides the interference measurement, in this case, indicating the interference is high 282. The LSA-IME 200 requests LSA spectrum information 283 from the LSA Controller 120, which responds with the respective information (e.g. Time/Location) on available LSA spectrum 284 under its control. The LSA-IME 200 then requests suitable/specific LSA spectrum for using in ICIC 285, which may be granted 286 to the UE 400 by the LSA-Controller 120.

At a later point, when the interference levels have dropped, the respective eNB, 301, may provide an updated information on the lower interference levels 287, which results in the LSA-IME requesting to terminate the LSA spectrum used for ICIC 288. In which case, the UE releases the LSA spectrum use (which was under exclusive use, in some examples), to the LSA controller 120, so that the respective LSA spectrum resources are available again for reuse elsewhere.

In conventional ICIC, in the case of high interference (e.g. high RNTPI, HHI, pico cell requesting ABS) neighboring cells would either not schedule any users in relevant PRB or only consider resource allocation for cell-center users requiring less transmission power. Whereas, in the proposed example mechanism, instead of avoiding scheduling of cell-edge users in concerned PRBs, the LSA-IME 200 assigns a portion of the available LSA spectrum to those users.

Thus, the proposed network centric LSA-IME ICIC approach will dynamically provide additional spectrum during ICIC which will be assigned to users experiencing high interference, providing an advantage of the network efficiency will be hugely increased at a relatively low cost, in particular in the cell-edge areas.

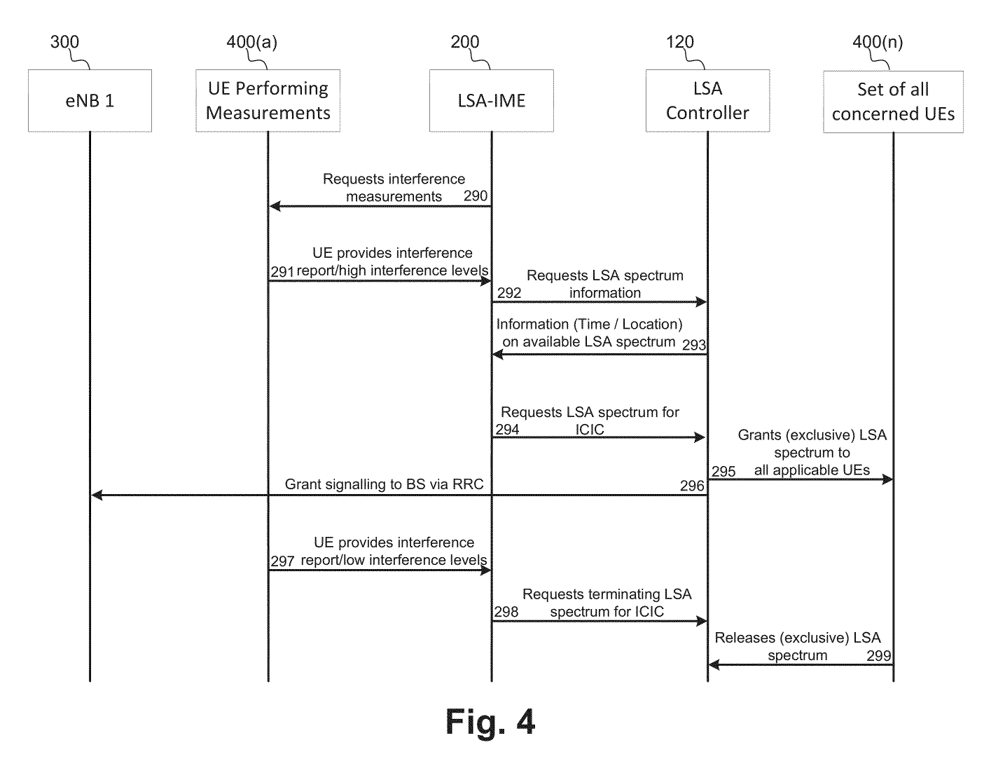

An example of an LTE Downlink Terminal Centric Interference Management signaling procedure is shown in FIG. 4. In this example the LSA-IME 200 requests interference measurements 290 from the Terminal (e.g. UE) 400(a) performing the measurements involved at this time. The UE performing the measurements 400(a) provides the requested interference measurement 291, in this case, indicating the interference is high. The LSA-IME 200 requests LSA spectrum information 292 from the LSA Controller 120, which responds with the respective information (e.g. Time/Location) on available LSA spectrum 293 under its control. The LSA-IME 200 then requests suitable/specific LSA spectrum for using in ICIC 294, which may be granted 295 to the UEs 400(n) by the LSA-Controller 120. The Grant may also be signaled to the Base station, for example via Radio Resource Control (RRC) signaling 295.

At a later point, when the interference levels have dropped, the respective UE carrying out the measurements, 400(a), may provide an updated interference information, this time indicating lower interference levels 297, which results in the LSA-IME 200 requesting to terminate the LSA spectrum used for ICIC 298. In which case, the UEs 400(n) release the LSA spectrum used 299 (which was under exclusive use, in some examples), to the LSA controller 120, so that the respective LSA spectrum resources are available again for reuse elsewhere.

In the terminal centric interference management, the interference message may be exchanged between users (UEs) and LSA-IME 200. In principle, UEs 400 measure interference levels and reports those to the LSA-IME 200. Based on the interference level reports, the LSA-IME 200 may allocate spectrum to UEs 400 experiencing sufficient (i.e. severe/strong enough) interference, for a certain time. The interference level report may, for example, contain the following information: Reference Signal Received Power (RSRP); Reference Signal Received Quality (RSRQ); and/or Worst/Best Companion Indicator (W/B-CI).

RSRP and RSRQ measurements may indicate a level of interference experienced by the UE in serving and neighboring cells, and W/B-CI may indicate worst or best users to be co-assigned to the new LSA based spectrum. W/BI-UI may include best/worst Precoding Matrix Index (PMI) and delta Channel Quality Indicator (CQI) information representing Signal-to-Noise Ratio (SNR) loss induced by the addition of another user on the same resource.

The LSA-IME 200 may coordinate the LSA spectrum allocated based on W/B-CI, i.e. only best companions may jointly share the new spectrum. The benefit of using W/B-CI is that LSA spectrum assigned to UEs may fit better to their interference conditions and it may ensure that UEs are not assigned to spectrum with a potential strong (different) interferer. This is to say, the allocation process takes into account what spectrum is being allocated elsewhere, so that there is no (or minimal) conflicting allocations happening. For example, the method may try to avoid allocating the same LSA spectrum to different UEs, so that they do not both interfere with each other after they each transition to the LSA spectrum usage.

FIGS. 5 to 18 shows a plurality of different possible assignments of LSA spectrum (and original ‘normal’ licensed spectrum) to users within cells, particularly users within the cell edges and cell middle. They are exemplary but non-exhaustive of the possible assignment arrangements that reduce/avoid inter-cell interference. The figures are shown in a form where only the changes are particularly pointed out, and so where the shading and shape of the cell areas is identical to a previous figure, the same information on those are meant. The Figures also all use the same shading key, as shown once on each Figure page. In each figure, a traditional arrangement of cells 501 is shown on the left, where cells centers have full access to available spectrum 503, and cell edge users have coordinated access to spectrum 502. Each figure shows how this previous arrangement may be altered for a given use case. The figures variously make use of different LSA spectrums/bands, such as LSA spectrum 1 602, LSA spectrum 2 603, LSA spectrum 3 604, LSA spectrum 4 605, LSA spectrum 5 606, as well as the ‘normal’ (i.e. non-shared access) licensed spectrum 601 originally assigned to an operator.

In a first case, as illustrated in FIG. 5, every 2^{nd} cell is subsequently i) fully allocated to licensed spectrum and ii) allocated to LSA spectrum at the cell edge—i.e. every other first cell pair is allocated as per i) and every other second cell pairing is allocated as per ii). In this figure, the LSA spectrum usage in cell edge areas is illustrated as diagonal line shaded 602, whilst usage of licensed spectrum is unshaded 601. Neighboring cells applying LSA spectrum in cell edge areas may create mutual interference and in those concerned cell-edge areas the application of inter-cell-interference mechanisms may still be required. Still, the overall inter-cell-interference issues are reduced. The idea is to operate some (typically hexagonal) cells in dedicated licensed spectrum bands, as the spectrum is traditionally allocated to such cells in 3GPP systems and other cellular communication systems. All cells (or at least some cells) just next to this dedicated spectrum cell will operate i) in a dedicated licensed spectrum band in the inner part of the cell (“inner hexagonal cell”), this can even be the same spectrum (or part of the same spectrum) as is used in the neighboring dedicated spectrum cell; ii) in a Licensed Shared Access (LSA) Spectrum band in the outer part of the cell which starts at the outer edge of the inner (typically hexagonal) cell and reaches up to the borders of the entire cell. Due to this approach, the LSA spectrum part of the cell (i.e., the cell edge=“outer” part of the cell) provides a separation area between the spectrum used in neighboring cells and the spectrum used in the “inner” part of the considered cell. It is thus assumed that the interference between neighboring cells will be reduced due to the separation by the outer LSA part of the cell. Typically, cells including the “inner” dedicated spectrum part and the “outer” LSA spectrum part (these may be called hybrid LSA/dedicate spectrum cells) are located “around” a cell in which only dedicated licensed spectrum is operated. Just next to those hybrid LSA/dedicate spectrum cells, typically cells with dedicated spectrum only may be positioned, then around those again hybrid LSA/dedicate spectrum cells, then again cells with dedicated spectrum only, etc. Those “outer” parts of LSA spectrum that are located just next to each other may either be operated in the same LSA spectrum (then, typically, some time/frequency/geographic area separation of the allocation of LSA resources between the various cells may be performed, typically during the cell deployment phase) or in different bands of the LSA spectrum (then, no specific separation approach is required). Optionally, the dedicated spectrum and LSA spectrum areas of the cells can be exchanged (then, the formerly dedicated-spectrum-only cells become LSA-spectrum-only cells and for the hybrid cells, the outer part of the cell uses dedicated spectrum and the inner part uses LSA spectrum.

For a fully orthogonal deployment, it is beneficial that various LSA bands are used and a correspondingly interleaved frequency allocation is used in neighboring cell edge areas, as shown in FIG. 6. FIG. 6 uses again (similar to FIG. 5) alternating cells which operate i) in a dedicated licensed spectrum band in the inner part of the cell (“inner hexagonal cell”), which can even be the same spectrum (or part of the same spectrum) as it is used in the neighboring dedicated spectrum cell and ii) in a Licensed Shared Access (LSA) Spectrum band in the outer part of the cell which starts at the outer edge of the inner (typically hexagonal) cell and reaches up to the borders of the entire cell. Also, dedicated spectrum only cells can be inserted if required. In neighboring hybrid cells (using LSA spectrum in the outer part and dedicated spectrum in the inner part of the cell), different LSA bands may be allocated to the concerned outer parts of the cells. Then, interference between the outer LSA parts of neighboring cells is avoided. Optionally, the dedicated spectrum and LSA spectrum areas of the cells can be inversed/exchanged (i.e. the formerly dedicate-spectrum-only cells become LSA-spectrum-only cells and for the hybrid cells, the outer part of the cell uses dedicated spectrum and the inner part uses LSA spectrum).

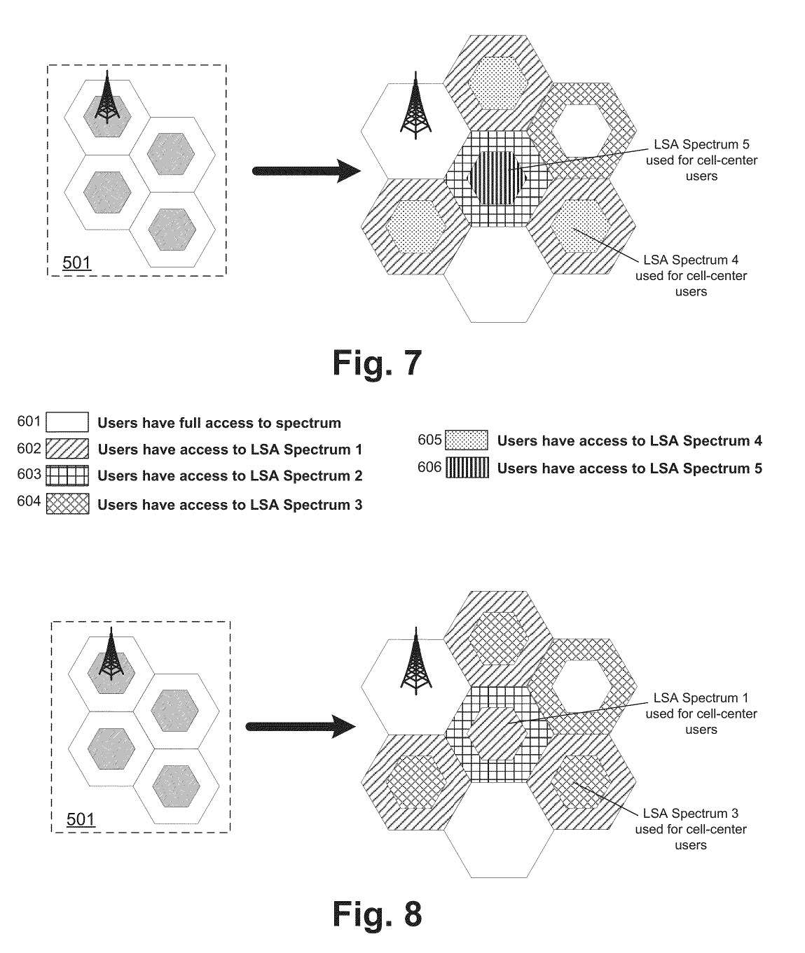

Furthermore, it is possible to use LSA spectrum in cell-center areas in order to further reduce interference levels in case that they impact cell-center performance, as shown in FIG. 7. FIG. 7 illustrates a configuration similar to the one in FIG. 6, but with the difference that whilst FIG. 6 employs dedicated licensed spectrum in the inner part of the hybrid cells, FIG. 7 introduces LSA spectrum usage also for the inner part of the hybrid cells. However, this LSA spectrum in the inner part may be a different part (e.g. band) of the LSA spectrum compared to the LSA spectrum used in the outer part of the same cell. The inner parts of neighboring hybrid cells can either use the identical LSA spectrum or the LSA spectrum can be allocated such that directly neighboring cells do use different parts of the LSA spectrum in the inner part of the cell. Also, this LSA spectrum used in the inner part is typically different from LSA spectrum used in the outer part of the concerned cell or the outer part of neighboring cells—possibly even the outer part of all cells.

FIG. 8 is similar to FIG. 7 but with the difference that the LSA spectrum allocated to the inner part of a hybrid cell is identical to the LSA spectrum used in the outer part of some neighboring cells (typically those cells surrounding the concerned hybrid cell). Typically, the corresponding LSA spectrum is not used in an identical way in all neighboring/surrounding cells because this may lead to interference between the outer parts of the neighboring/surrounding cells themselves. Therefore, for each surrounding cell for which the LSA spectrum is used, that is identical to the LSA spectrum allocated to the inner part of the concerned hybrid cell, the directly neighboring surrounding cell is using a different LSA band part. Finally, one in two cells (e.g., if the surrounding cells are numbered clock-wise or counter-clock-wise from 1, 2, 3, . . . all pair numbered cells may use the LSA spectrum identical to the LSA spectrum of the inner part of the concerned cell while all non-pair numbered cells need to use some other LSA spectrum; alternatively, all non-pair numbered cells may use the LSA spectrum identical to the LSA spectrum of the inner part of the concerned cell while all pair numbered cells need to use some other LSA spectrum) of the surrounding cells of a concerned hybrid cell is using the LSA spectrum identical to the LSA spectrum used in the inner part of the concerned hybrid cell.

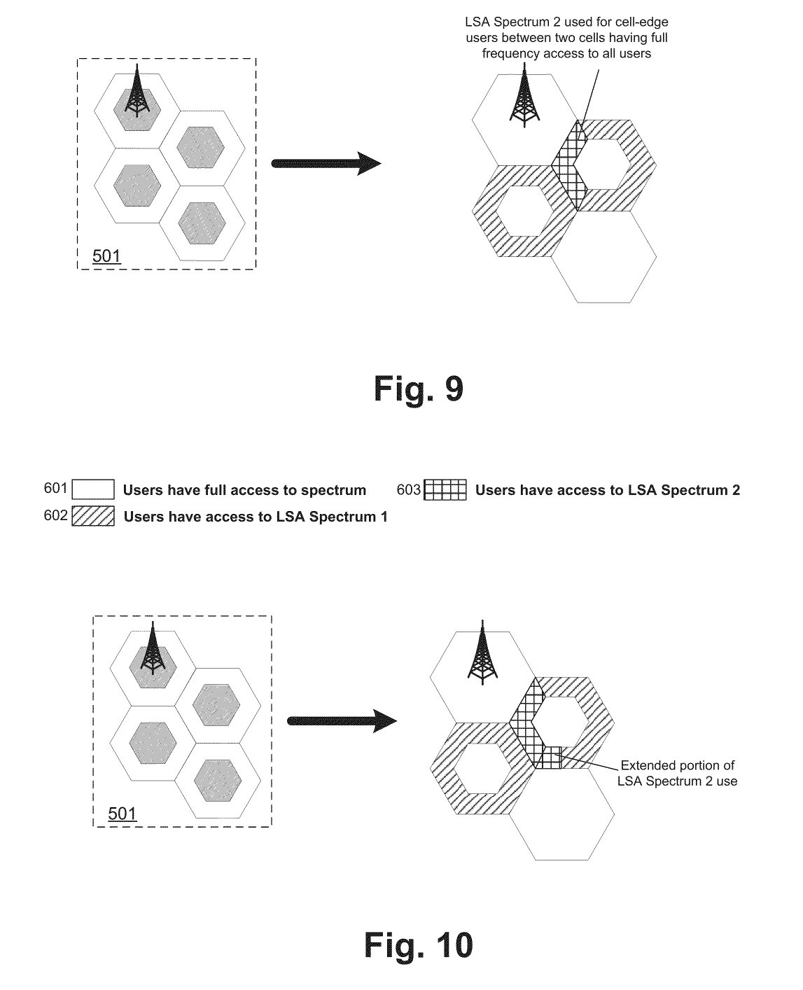

In order to avoid the inter-cell-interference issues in the case of FIG. 5, a slightly more complex scheme is proposed using sectorisation as well as use of different LSA bands (602-606). FIG. 9 corresponds to the case in which dedicated licensed spectrum (or possibly some LSA spectrum which is not used in the proximity of the concerned cell—i.e. current cell of interest) is used in the inner part of a concerned hybrid cell. In order to avoid interference of the outer part of the concerned cell with the outer part of the neighboring cell (operating in the same LSA spectrum band), the following is proposed: The neighboring hybrid cell is operating the identical LSA band as is in use for the outer part of the considered cell. However, in this example, in the specific section of the outer part of the neighboring cell which is immediately next to the outer part of the concerned cell, a different LSA spectrum band is applied. This example allocation of a different LSA spectrum thus concerns ⅙^{th} of the outer part of the cell in case of a hexagonal cell. Optionally, the immediately neighboring sub-parts of the outer part of the cell can also be operated in the other LSA spectrum. In FIG. 9, it is illustrated that the upper neighboring sub-part is also operated in another LSA spectrum band—the same can be done for the lower sub-part of the outer cell part or for both neighboring parts. In a further alternative, even more of those sub-parts or even parts of those sub-parts only can be allocated to different LSA bands compared to the LSA band used in the outer cell part of the concerned cell. Those parts of a sub-part may for example consist in half of a ⅙^{th} sub-part in the context of a hexagonal cell.

FIG. 10 corresponds to FIG. 9, but with the difference that sub-parts are used—in this example case half of the sub-part of the outer neighboring cell is allocated to a different LSA spectrum (compared to the LSA spectrum allocated to the rest of the considered outer part of the cell) which is located just below the sub-part of the neighboring hybrid cell that is just opposite a hybrid cell that is also using LSA spectrum in the outer part of the cell (the identical LSA spectrum is used for the rest of the outer part of the neighboring cell which is not located directly next to the outer part of the concerned cell).

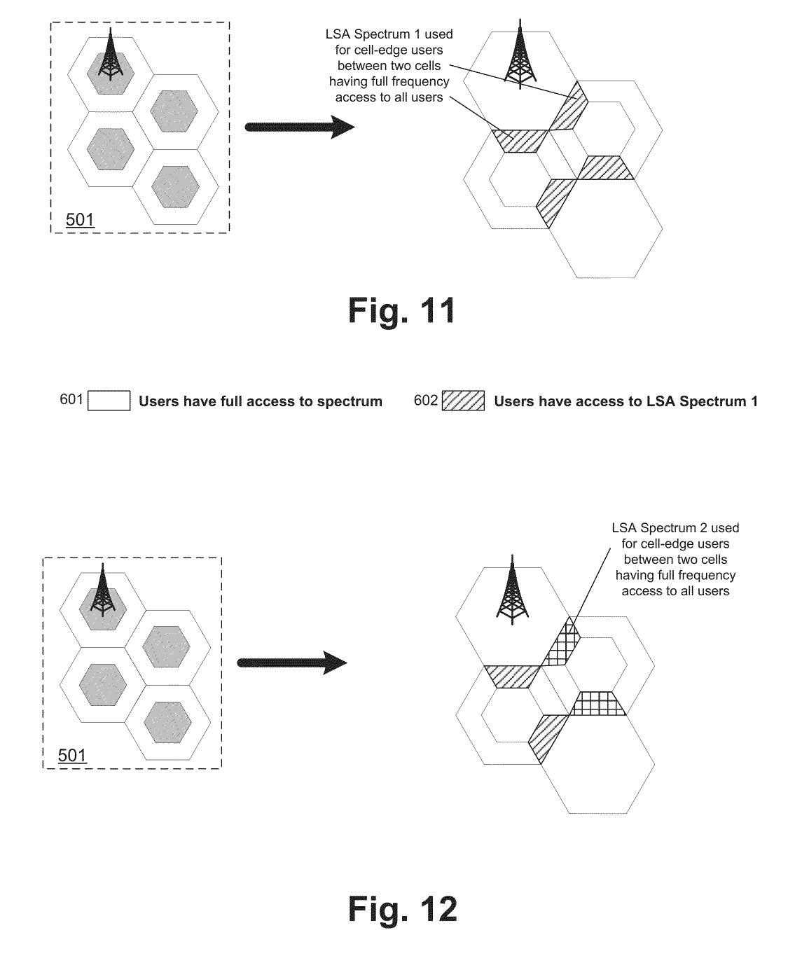

FIG. 11 illustrates a configuration in which the sub-parts (in the context of hexagonal cells, a sub-part consists of ⅙^{th} of the concerned outer part of the cell) of the outer parts of neighboring cells are allocated to LSA/dedicated licensed spectrum in the following way: i) those sub-parts of the outer part of the cell which are directly located next to each other are using dedicated licensed spectrum. Just above and below this sub-part of the first cell and second cell, one LSA spectrum band is allocated to the concerned sub-parts of the outer cell. The remaining sub-parts of the outer parts of the concerned cells are using dedicated licensed spectrum or alternatively other LSA spectrum. Optionally, the inverse may be used—i.e. the dedicated spectrum and LSA spectrum (sub-)areas of the cells can be exchanged (then, the formerly dedicated-spectrum-only cells become LSA-spectrum-only cells and for the hybrid cells, the outer part of the cell uses dedicated spectrum and the inner part uses LSA spectrum).

FIG. 12 illustrates a configuration in which the sub-parts (in the context of hexagonal cells, a sub-part consists of ⅙^{th} of the concerned outer part of the cell) of the outer parts of neighboring cells are allocated to LSA/dedicated licensed spectrum in the following way: i) those sub-parts of the outer part of the cell which are directly located next to each other are using dedicated licensed spectrum. Just above and below this sub-part of the first cell, one LSA spectrum band is allocated to the concerned sub-parts of the outer cell. Just above and below this sub-part of the second cell, another LSA spectrum band is allocated to the concerned sub-parts of the outer cell. The remaining sub-parts of the outer parts of the concerned cells are using dedicated licensed spectrum or alternatively other LSA spectrum. Optionally, the dedicated spectrum and LSA spectrum (sub-)areas of the cells can be exchanged (then, the formerly dedicate-spectrum-only cells become LSA-spectrum-only cells and for the hybrid cells, the outer part of the cell uses dedicated spectrum and the inner part uses LSA spectrum).

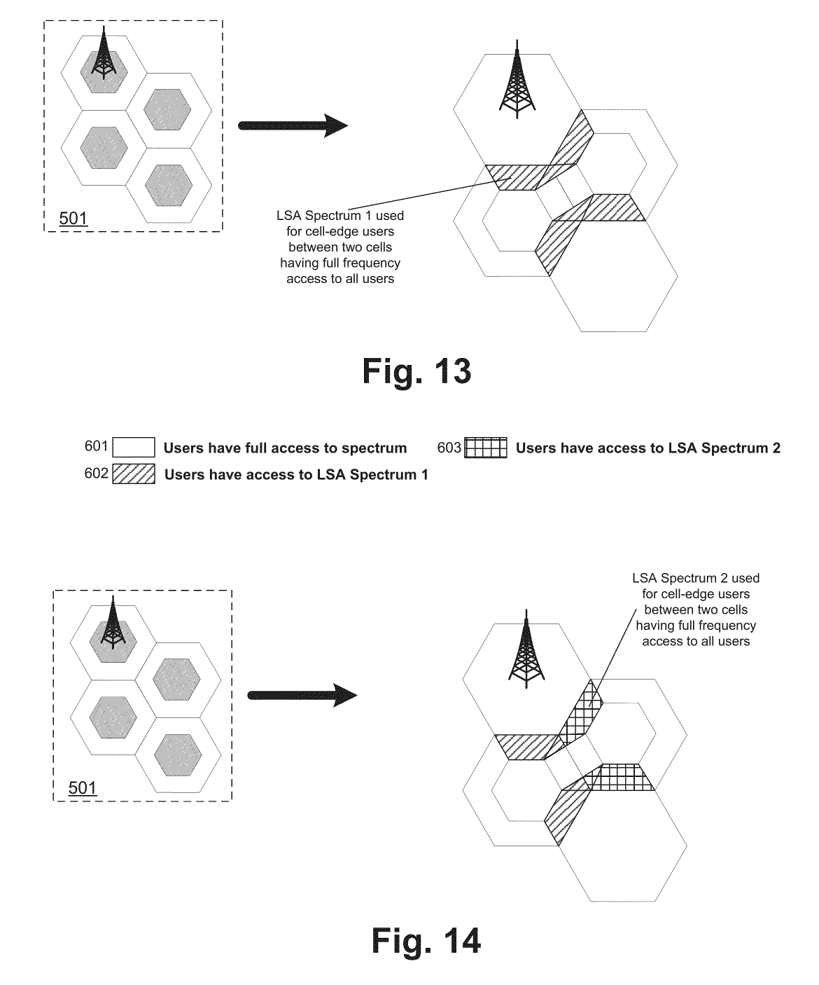

FIG. 13 illustrates a configuration, in which neighboring sub-parts of neighboring cells are using the identical LSA spectrum band. The sub-parts which typically consist of ⅙^{th} of the outer part of the cell for a hexagonal case, are slightly extended by a triangular area in which the same LSA spectrum is used. This triangular area is created by i) drawing a line between 2 inner neighboring edges of the outer part of the cell and ii) drawing a line from each of those inner neighboring edges to the opposite outer corner of the neighboring cell as illustrated in the figure. Then the crossing of those two lines created in item ii) is taken to be connected to the two inner edges of item i). In the corresponding triangle surface, the same LSA spectrum is used as in the neighboring sub-parts of the outer part of the cell.

FIG. 14 illustrates an example use case which is similar to FIG. 13, but with the difference that a different LSA band is used for the directly neighboring sub-parts of the neighboring cells.

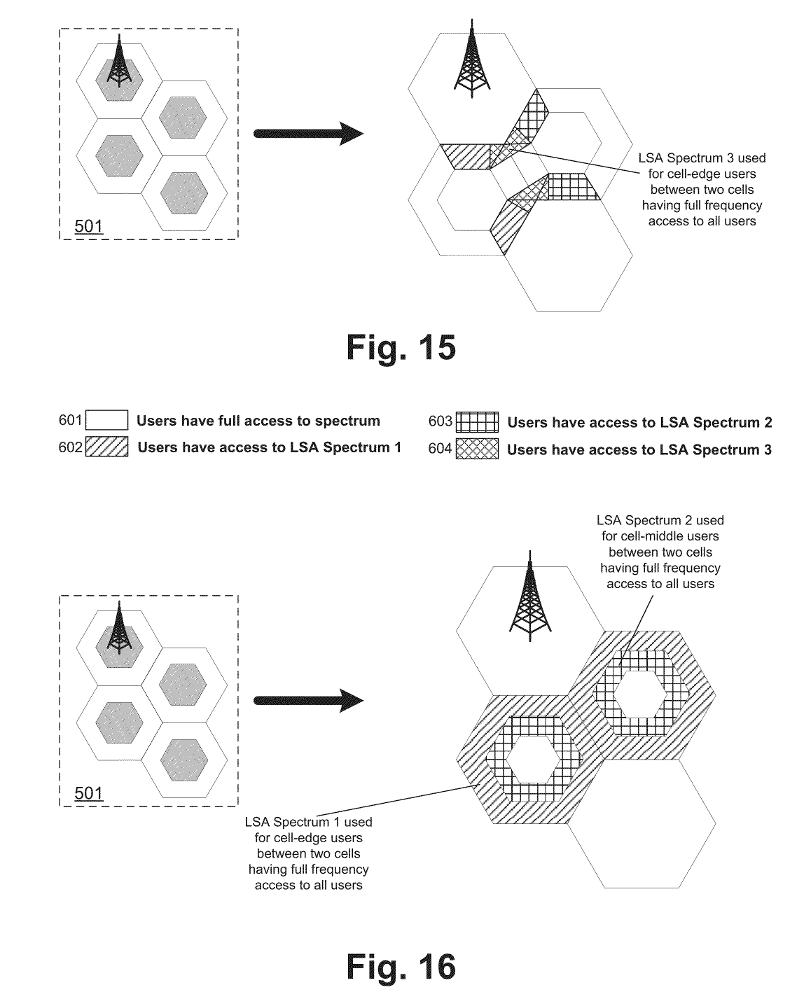

FIG. 15 illustrates an example use case which similar to FIG. 14, but with the difference that a third LSA band (different from the first two LSA bands) is used for the intersecting parts of neighboring sub-parts of the neighboring cells

In case of very high inter-cell-interference issues, it may occur that not only the immediate cell edge areas are concerned. Also, areas further inside a considered cell may be concerned. This is to say, in order to introduce further capacity, it may also be useful to apply several “layers” of LSA, i.e. the “outer” layer may apply a first LSA band while the next layer may apply a second LSA band, etc. FIG. 16 shows this extended usage of a three layered cell, where an inner, middle and outer part of the cell is introduced. All outer parts are using a first LSA spectrum band (identical for all outer parts), all middle parts are using a second LSA spectrum band (identical for all middle parts) and all inner parts are using a third LSA spectrum band (identical for all inner parts) or alternatively a dedicated licensed spectrum band.

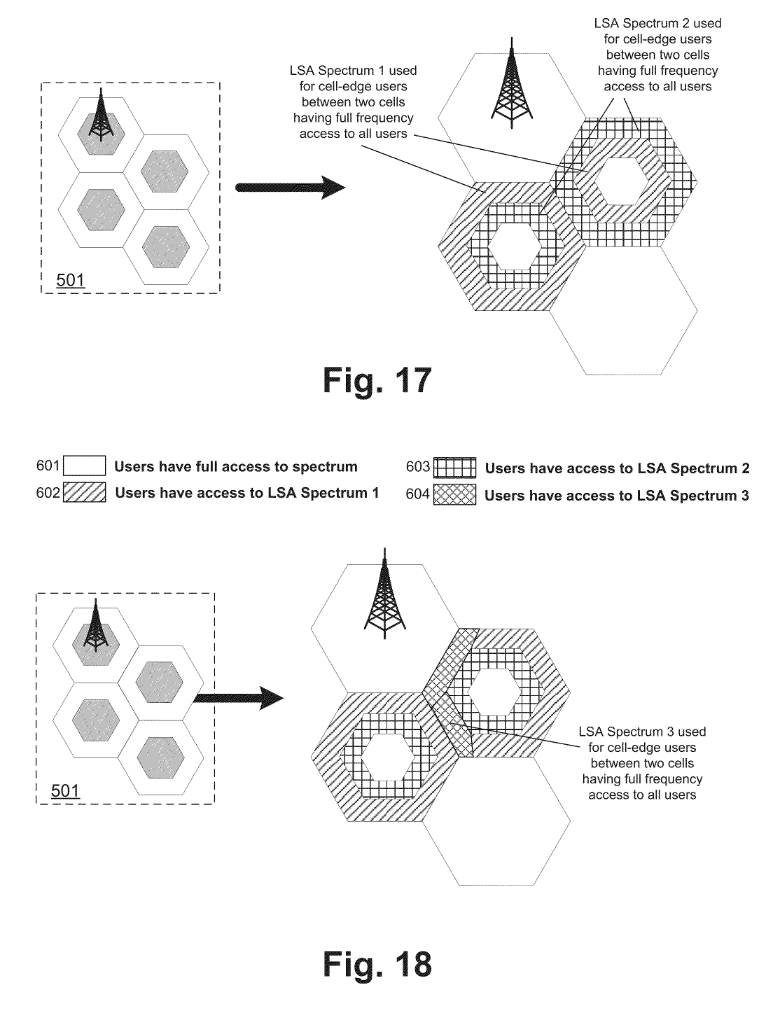

In order to further reduce interference aspects, the usage of LSA bands in the outer (cell edge) area and cell areas further towards the cell center may be interleaved as illustrated below. Consequently different LSA bands are immediately neighboring each other. FIG. 17 corresponds to the configuration of FIG. 16, but with the difference that the allocation of 3 LSA bands to the inner/middle/outer part of the frame are interleaved (i.e., the order is modified) between neighboring cells.

FIG. 18 illustrates a use case configuration which is similar to FIG. 16, but with the following difference: In order to avoid interference of the outer part of the concerned cell with the outer part of the neighboring cell (operating in the same LSA spectrum band), the following is proposed: The neighboring hybrid cell is operating the identical LSA band as it is the case for the outer part of the considered cell. However, in the specific section of the outer part of the neighboring cell which is immediately next to the outer part of the concerned cell, a different LSA band is applied. This allocation of a different LSA spectrum thus concerns ⅙^{th} of the outer part of the cell in case of a hexagonal cell. Optionally, the immediately neighboring sub-parts of the outer part of the frame can also be operated in the other LSA spectrum. In FIG. 18, it is illustrated that the upper neighboring sub-part is also operated in the other LSA spectrum band—the same can be done for the lower sub-part of the outer cell part or for both neighboring parts. In a further alternative, even more of those sub-parts or even parts of those sub-parts only can be allocated to different LSA bands compared to the LSA band used in the outer cell part of the concerned cell. Those parts of a sub-part may for example consist in half of a ⅙^{th} sub-part in the context of a hexagonal cell.

In the foregoing descriptions of FIGS. 5-18, different sub-parts may be used, other than the above described hexagon based ⅙^{th} sub-parts.

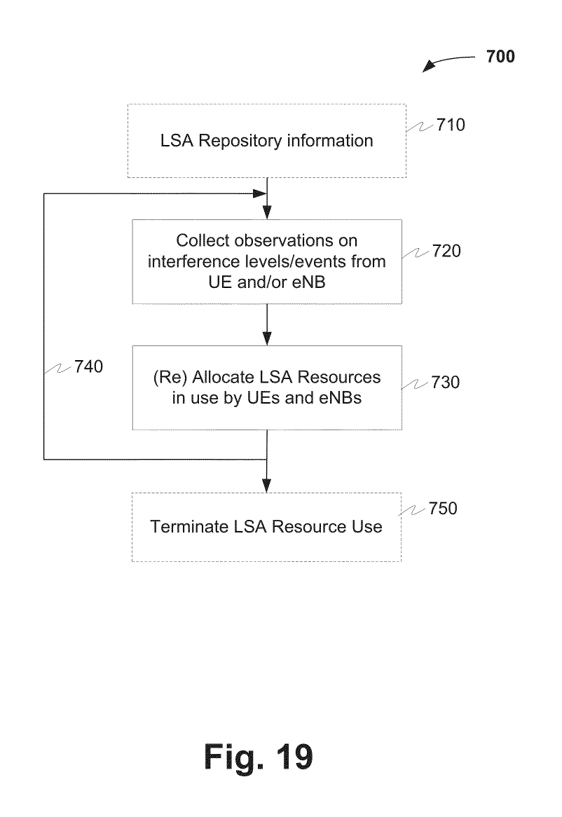

FIG. 19 shows an example flowchart of a method 700 according to example embodiments of the invention. The method starts by optionally receiving LSA spectrum resources information 710 from the LSA repository, or another entity, such as a sensing entity. The method proceeds by collecting observations on interference levels (or events) from respective (i.e. those that are to be involved in the LSA based inter cell interference mitigation techniques described herein) UEs and/or eNBs 720. Based on the collected interference information, the LSA spectrum resources available (according to the LSA repository/sensing entities) are allocated 730 to respective UEs and eNBs. The process may re-iterate around 740, thereby providing continuously assessed LSA based interference mitigation, or it may terminate LSA spectrum resources usage 750.

Example embodiments may be used in a variety of applications including transmitters and receivers of a wireless network equipment, although the present invention is not limited in this respect. Wireless network equipment specifically included within the scope of the present disclosure include, but are not limited to, network interface cards (NICs), network adaptors, fixed or mobile client devices, relays, base stations, macro/femto/pico cells, gateways, bridges, hubs, routers, access points, or other network devices. Further, the wireless network equipment may be or include radio systems, such radio systems within the scope of the invention may be implemented in cellular radiotelephone systems, satellite systems, two-way radio systems as well as computing devices including such radio systems including personal computers (PCs), tablets and related peripherals, personal digital assistants (PDAs), personal computing accessories, hand-held communication devices and all systems which may be related in nature and to which the principles of the inventive embodiments could be suitably applied.

According to some embodiments, advanced UE receiver/transmitter structures and corresponding eNB transmitter/receiver structures are provided.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or machine readable storage such as, for example, DVD, memory stick or solid state medium. It will be appreciated that the storage devices and storage media are embodiments of non-transitory machine-readable storage that are suitable for storing a program or programs comprising instructions that, when executed, implement embodiments described and claimed herein. Accordingly, embodiments provide machine executable code for implementing a system, device or method as described herein or as claimed herein and machine readable storage storing such a program. Still further, such programs may be conveyed electronically via any medium such as a communication signal carried over a wired or wireless connection and embodiments suitably encompass the same.

Any such hardware can take the form of a processor, suitably programmable, such as for example, a programmable general purpose processor designed for mobile devices, as a FPGA, or an ASIC, which together constitute embodiment of processing circuitry configured or configurable to perform the functions of the above examples and embodiments. Any such hardware can also take the form of a chip or chip set arranged to operate according to any one or more of the above described diagrams, such diagrams and associated descriptions being taken jointly or severally in any and all permutations.

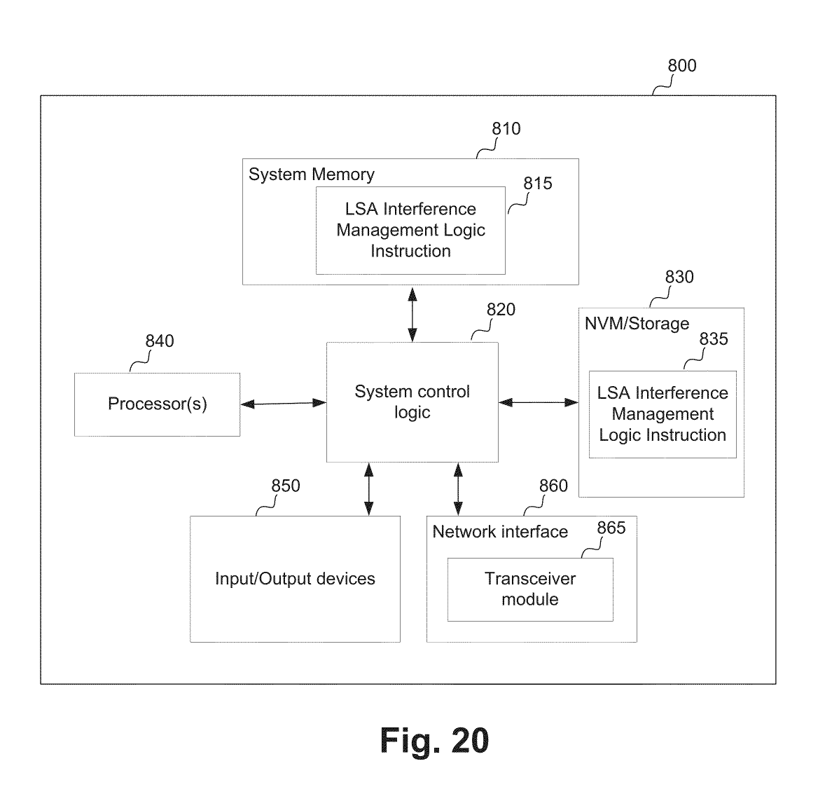

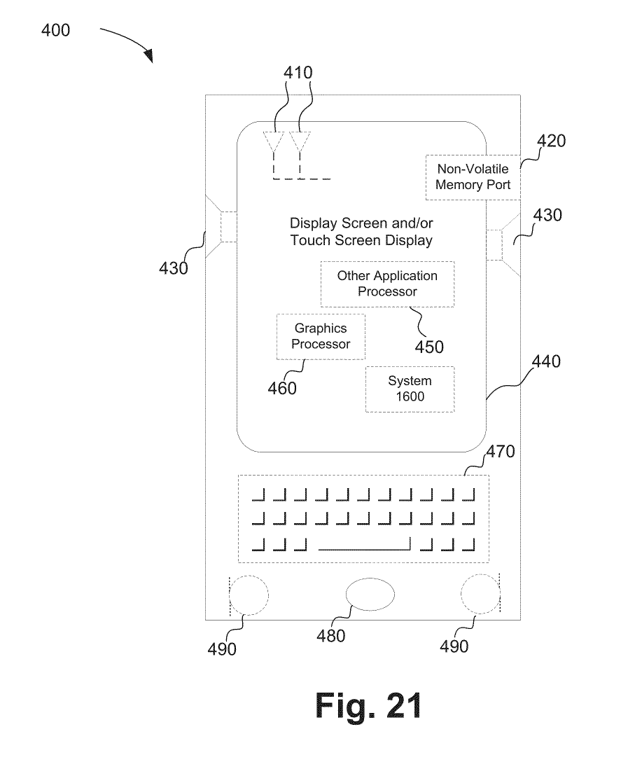

The eNB(s) 300, 301 and UEs 400 described herein may be implemented into a system 800 using any suitable hardware and/or software to configure as desired. FIG. 20 illustrates such an example system 800, suitable for implementing an eNB or UE, or any other wireless network equipment according to examples disclosed herein.

The system shown in FIG. 20 comprises one or more processor(s) 840, system control logic 820 coupled with at least one of the processor(s) 840, system memory 810 coupled with system control logic 820, non-volatile memory (NVM)/storage 830 coupled with system control logic 820, and a network interface 860 coupled with system control logic 820. The system control logic 820 may also be coupled to Input/Output devices 850.

Processor(s) 840 may include one or more single-core or multi-core processors. Processor(s) 840 may include any combination of general-purpose processors and dedicated processors (e.g., graphics processors, application processors, baseband processors, etc.). Processors 840 may be operable to carry out the above described methods, using suitable instructions or programs (i.e. operate via use of processor, or other logic, instructions). The instructions may be stored in system memory 810, as LSA based interference management entity logic instruction memory portion 815, or additionally or alternatively may be stored in (NVM)/storage 830, as NVM interference mitigation logic instruction portion 835, to thereby instruct the one or more processors 840 to carry out the improved network assisted parameter estimation techniques described herein.

Processors(s) 840 may be configured to execute the embodiments of FIGS. 2-19 in accordance with various embodiments.

System control logic 820 for one embodiment may include any suitable interface controllers to provide for any suitable interface to at least one of the processor(s) 840 and/or to any suitable device or component in communication with system control logic 820. System control logic 820 for one embodiment may include one or more memory controller(s) (not shown) to provide an interface to system memory 810. System memory 810 may be used to load and store data and/or instructions, for example, for system 800. System memory 810 for one embodiment may include any suitable volatile memory, such as suitable dynamic random access memory (DRAM), for example.

NVM/storage 830 may include one or more tangible, non-transitory computer-readable media used to store data and/or instructions, for example. NVM/storage 830 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example. The NVM/storage 830 may include a storage resource physically part of a device on which the system 800 is installed or it may be accessible by, but not necessarily a part of, the device. For example, the NVM/storage 830 may be accessed over a network via the network interface 860.

System memory 810 and NVM/storage 830 may respectively include, in particular, temporal and persistent copies of, for example, the instructions memory portions holding the LSA based interference management process logic 815 and 835, respectively. LSA based interference management process logic instructions portions 815 and 835 may include instructions that when executed by at least one of the processor(s) 840 result in the system 800 implementing the method(s) of any described embodiment, for example method 700 in FIG. 19, and any of the further described improvements on the broad method. In some embodiments, instruction portions 815 and 835, or hardware, firmware, and/or software components thereof, may additionally/alternatively be located in the system control logic 820, the network interface 860, and/or the processor(s) 840.

Network interface 860 may have a transceiver module 865 to provide a radio interface for system 800 to communicate over one or more network(s) (e.g. wireless communication network) and/or with any other suitable device. In various embodiments, the transceiver 865 may be integrated with other components of system 800. For example, the transceiver 865 may include a processor of the processor(s) 840, memory of the system memory 810, and NVM/Storage of NVM/Storage 830. Network interface 860 may include any suitable hardware and/or firmware. Network interface 860 may be operatively coupled to a plurality of antennas to provide a multiple input, multiple output radio interface. Network interface 860 for one embodiment may include, for example, a network adapter, a wireless network adapter, a telephone modem, and/or a wireless modem.

For one embodiment, at least one of the processor(s) 840 may be packaged together with logic for one or more controller(s) of system control logic 820. For one embodiment, at least one of the processor(s) 840 may be packaged together with logic for one or more controllers of system control logic 820 to form a System in Package (SiP). For one embodiment, at least one of the processor(s) 840 may be integrated on the same die with logic for one or more controller(s) of system control logic 820. For one embodiment, at least one of the processor(s) 840 may be integrated on the same die with logic for one or more controller(s) of system control logic 820 to form a System on Chip (SoC).

In various embodiments, the I/O devices 850 may include user interfaces designed to enable user interaction with the system 800, peripheral component interfaces designed to enable peripheral component interaction with the system 800, and/or sensors designed to determine environmental conditions and/or location information related to the system 800.

FIG. 21 shows an embodiment in which the system 800 implements a UE 400, in the specific form of a mobile device.

In various embodiments, user interfaces could include, but are not limited to, a display 440 (e.g., a liquid crystal display, a touch screen display, etc.), a speaker 430, a microphone 490, one or more cameras 480 (e.g., a still camera and/or a video camera), a flashlight (e.g., a light emitting diode flash), and a keyboard 470, one or more antennas 410, a NVM memory port 420, system 800 of FIG. 20, but may also include a further, e.g. dedicated, graphics processor 460 and/or other application processors 450. These latter additional processors being for multimedia and more general computing processing, for example (e.g. as may be particularly used in a tablet computing device, etc).

In various embodiments, the peripheral component interfaces may include, but are not limited to, a non-volatile memory port, an audio jack, and a power supply interface.

In various embodiments, the sensors may include, but are not limited to, a gyro sensor, an accelerometer, a proximity sensor, an ambient light sensor, and a positioning unit. The positioning unit may also be part of, or interact with, the network interface 860 to communicate with components of a positioning network, e.g., a global positioning system (GPS) satellite.

In various embodiments, the system 800 may be a mobile computing device such as, but not limited to, a laptop computing device, a tablet computing device, a netbook, a mobile phone, etc. In various embodiments, system 800 may have more or less components, and/or different architectures.

In various embodiments, the implemented wireless network may be a 3rd Generation Partnership Project's long term evolution (LTE) advanced wireless communication standard, which may include, but is not limited to releases 8, 9, 10, 11 and 12, or later, of the 3GPP's LTE-A standards.

Examples may provide an entity in a wireless network, for example called an LSA Interference Management Entity (LSA-IME), which provides a centralized interference management process by applying suitable allocation of LSA spectrum resources (LSA frequencies, times, geographic regions, etc) for use in communicating between one or more base stations, such as eNBs, and one or more terminal devices, such as UEs.

In the Base Station (e.g. eNB) or in the LSA-IME, exemplary methods may include the steps of: i) detecting interference issues (i.e., Mobile Devices/UEs undergoing interference, and the levels of said interference), ii) detecting which interfered UEs are LSA capable by suitable signaling between the Base Station and/or LSA-IME, iii) allocating additional LSA spectrum to identified LSA capable UEs by suitable signaling between the Base Station and/or LSA-IME, iv) allocating eICIC usage to non-LSA-capable UEs by suitable signaling between the Base Station and/or LSA-IME, v) track interference changes due to the (currently) applied LSA/eICIC usage, and vi) iterate the interference detection and reporting processes, so that the method may further include adding/removing LSA resources and applying eICIC to selected users, dependent on the currently experience interference at each UE and/or eNB.

In the UE, exemplary methods may include the steps of: i) receiving triggers from the Base Station and/or LSA-IME to report interference issues, ii) providing interference measurements to the Base Station and/or LSA-IME, iii) receiving triggers to apply additional LSA spectrum or eICIC, and vi) applying requested reconfiguration as indicated by the Base Station and/or LSA-IME.

In some examples, the interference mitigation method can be initiated within the UE. The UE may then perform the following steps: i) On its own initiative, any given UE(s) measure interference levels (currently being) experienced by those given UE(s) and preferred/non-preferred UEs and reports those to the Base Station and/or LSA-IME, ii) UE(s) awaits decision on interference mitigation technique by the Base Station and/or LSA-IME, iii) UE(s) receives decision on interference mitigation technique by the Base Station and/or LSA-IME and iv) UE(s) applies decision on interference mitigation technique provided by the Base Station and/or LSA-IME. On the Base Station and/or LSA-IME side, the following tasks may be performed: i) UE measurements (triggered by UEs) are received, ii) Based on interference level report, the Base Station and/or LSA-IME allocates spectrum to UEs experiencing severe enough interference for a certain time, iii) the Base Station and/or LSA-IME sends reconfiguration requests to concerned UEs to either apply new LSA spectrum for interference mitigation or eICIC (i.e. normal licensed spectrum only).

The afore-mentioned LSA (Licensed Shared Access) may be typically employed in the 2.3-2.4 GHz band(s) in Europe (at least in a first phase, further frequency bands may follow in due course). In the US, the term “LSA” may not be used, but rather the term “spectrum access system (SAS)”, examples of which may be employed in other bands, for example the 3.5 GHz band(s). The European LSA system may be a 2-tier system, building on the terms “Incumbents” (i.e., spectrum owners) and “LSA Licensees”. In the US, a 3-tier Spectrum Sharing approach may be used comprising (1) Incumbent Access; (2) Priority Access; and (3) General Authorized Access (GAA).

Whilst examples have been disclosed in terms of LTE and LTE-A wireless networks, example and the teachings herein may equally be applied to other wireless network standards such as, but not limited to: cellular wide area radio communication technology (which may include e.g. a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 12), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-70 GHz and above), WiFi (IEEE 802.11a/b/g/n/ac/ad/af/etc.), WiMAX (IEEE 802.16a/e), etc.

Examples provide a shared access interference mitigation entity apparatus for managing interference in a wireless network, the apparatus comprising processing circuitry arranged to receive interference information from wireless network equipment operative within the wireless network, receive shared access repository information on available shared access spectrum resources and allocate shared access spectrum resources for use in inter cell interference mitigation to the wireless network equipment dependent upon the received interference information. Examples also provide a corresponding method of interference mitigation and/or management in a wireless network.

In examples, ‘shared access’ may be any currently used (or to be envisaged) shared spectrum access scheme, including but not limited to: LSA, ASA (Authorized Shared Access), 3-tier model (used in US), spectrum access system (SAS, which may be another term for the US 3-tier model and possibly others.

Shared access repository information may be derived from sensing entities in the wireless network, where the sensing entities may be standard network equipment suitably configured for sensing duties, such as UE or eNB, or the sensing entities may be dedicated sensing entities, A mix of these types may also be used.

In some examples, the wireless network equipment comprises an eNB or UE. In some examples, the apparatus (wireless network equipment) is further configured to access a shared access repository information directly or via a shared access controller.

In some examples, the shared access repository information includes information of shared access spectrum resources available in a pre-determined geographic area and over a pre-determined period of time, and wherein allocation of shared access spectrum resources is dependent on the shared access repository information.

In some examples, to receive shared access repository information on available shared access spectrum resources comprises to receive observations from the wireless network equipment on interference events based upon measurements carried out by the wireless network equipment.

In some examples, the shared access repository may be any means for storing shared access data (e.g. available LSA spectrum data) provided from incumbents, and/or measured/sensed by equipment connected to or forming part of the wireless network. This is to say the source of the information in the repository may be dependent on the particular implementation details in any given use-case.

In some examples, the apparatus is further arranged to re-allocate shared access spectrum resources dependent upon one or more further subsequently received interference information from wireless network equipment. Optionally the re-allocation may be geographically and/or spare and/or frequency dependent.

In some examples, apparatus is further arranged to instigate hand-off of a portion of the wireless network equipment to another spectrum resource. the portion of the wireless network in which the disclosed shared access interference mitigation methods and apparatus are applied may be any portion of the wireless network, including but not limited to a sub-portion of the UE upwards.

In some examples, the another spectrum resource is either a different shared access spectrum resource portion or a non-shared access spectrum resource. In some examples, the shared access interference mitigation entity is arranged to manage interference for a single network operator and/or single geographic area having a single shared access repository.

Some examples may use a shared access repository that has a first portion that is inside a network provider/mobile operator, and a second portion outside the same network provider/mobile operator, for example, provided for interworking with other network providers/mobile operators. The first portion may be private to the network provider/mobile operator and the second portion may be public to other network providers/mobile operators. Alternatively, the first and second portions may both be public, but only the second portion is writeable by other network providers/mobile operators than the repository “owner”.

In some examples, the apparatus is further arranged to terminate shared access spectrum resources use by any portion of the wireless network. In some examples, the UE provides interference information to the shared access interference mitigation entity comprising any one or more of: Reference Signal Received Power (RSRP); Reference Signal Received Quality (RSRQ); Worst/Best Companion Indicator (W/B-CI).

In some examples, the eNB provides interference information to the shared access interference mitigation entity using any one or more of: an LTE Downlink Relative Narrowband Transmit Power Indicator (RNTPI) sent to one or more neighbour cells; an LTE Uplink High Interference Indicator (HII) and Overload Indicator (OI); an eICIC invoke message from an interfering cell.

Examples also provide an eNB for use in a wireless network, comprising processing circuitry arranged to detect interference issues occurring on any wireless link in use on the eNB, detect which UEs operating with the eNB are capable of using LSA spectrum resources, allocate LSA spectrum resources to at least one of the UEs detected to be capable of using LSA spectrum resources to mitigate interference, track interference changes due to the allocation of LSA spectrum resources to at least a portion of the at least one UE, and re-allocate or terminate the allocation of LSA spectrum resources to the at least a portion of the at least one of the UEs dependent on the tracked interference changes.

In some examples that use the US based SAS model, tier-3 users may also be present which access the spectrum opportunistically. The herein described approach may be extended to also include the handling of such tier-3 users by detecting them accessing the spectrum, then identifying any interference events and executing countermeasures of the same type and application, as the ones proposed in this document for tier 1 and tier 2 users.

In some examples, the eNB is further arranged to allocate eICIC to UEs not capable of using LSA spectrum resources, dependent on the tracked interference changes or allocation of LSA spectrum resources to the at least one portion of the at least one of the UEs detected to be capable of using LSA spectrum resources.

In some examples, to detect interference issues or track interference changes comprises signalling interference information to or from the eNB, wherein the signalling used comprises any one or more of: an LTE Downlink Relative Narrowband Transmit Power Indicator (RNTPI) sent to one or more neighbour cells; an LTE Uplink High Interference Indicator (HII) and Overload Indicator (OI); an eICIC invoke message from an interfering cell. In some examples, the signalling occurs over an X2 signalling link, between the eNB and an LSA-IME.

In some examples, the signalling comprises any one or more of: a request for LSA spectrum resources availability information; a request for LSA spectrum resources usage; LSA spectrum resources availability information; LSA spectrum resources usage grant; LSA spectrum resources usage termination; LSA spectrum resources usage release; information on interference being experienced by any involved wireless network equipment.

Examples also provide a UE for use in a wireless network, comprising processing circuitry arranged to receive a signal triggering reporting of detected interference levels occurring on any wireless link in use by the UE, send a report on the detected interference levels occurring on any wireless link in use by the UE, receive a signal triggering use of allocated LSA spectrum resources or eICIC resources by the UE and use the allocated LSA spectrum resources or eICIC resources.

Examples also provide a UE for use in a wireless network, comprising processing circuitry arranged to measure interference levels occurring on any wireless link in use by the UE, report the measured interference levels to an eNB or LSA-IME, receive an instruction to use specified LSA spectrum resources from the eNB or LSA-IME, and follow the instruction to use specified LSA spectrum resources from the eNB or LSA-IME.

Examples also provide an eNB for use in a wireless network, comprising processing circuitry arranged to receive a measured interference levels report on interference occurring on any wireless link in use by a UE operating with the eNB from said UE, report the measured interference levels to an LSA-IME, receive an instruction to use a specified LSA spectrum resources from the LSA-IME and forward the instruction to a specified UE operating with the eNB.

In some examples, the processing circuitry is further arranged to receive and forward an instruction to re-allocate or terminate LSA spectrum resources usage by the UE. In some examples, the processing circuitry is further arranged to receive and forward an instruction to use eICIC resources by the UE.

Examples also provide corresponding aspects to any of the above described examples, including but not limited to corresponding methods, hardware, and a non-transitory machine readable storage medium having instructions embodied thereon, the instructions which when executed by one or more processors perform any corresponding method. Whilst in the foregoing, the term LSA-IME has been used, other terms for the same functional entity may be in use instead, for example LSA Spectrum Management (Entity) (LSA SM(E) or just SM(E)), LSA Neighbouring Spectrum Management (Entity) (LSA NSM(E) or just NSM(E)), LSA External Spectrum Management (Entity) (LSA ESM(E) or just ESM(E)), LSA Foreign Spectrum Management (Entity) (LSA FSM(E) or just FSM(E)), LSA Spectrum Control (Entity) (LSA SC(N) or just SC(N)), LSA Neighbouring Spectrum Control (Entity) (LSA NSC(N) or just NSC(N)), LSA External Spectrum Control (Entity) (LSA ESC(N) or just ESC(N)), LSA Foreign Spectrum Control (Entity) (LSA FSC(N) or just FSC(N)), LSA Access Control (Entity) (LSA AC(E) or just AC(E)), LSA Neighbouring Access Control (Entity) (LSA NAC(E) or just NAC(E)), LSA External Access Control (Entity) (LSA EAC(E) or just EAC(E)), LSA Foreign Access Control (Entity) (LSA FAC(E) or just FAC(E)), LSA Foreign Access Management (Entity) (LSA FAM(E) or just FAM), LSA Neighbouring Systems Management (Entity) (LSA NSM(E) or just NSM(E)), LSA Interference Control (Entity) (LSA IC(E) or just IC(E)), LSA Neighboring Interference Control (Entity) (LSA NIC(E) or just NIC(E)), LSA External Interference Control (Entity) (LSA EIC(E) or just EIC(E)), LSA Foreign Interference Control (Entity) (LSA FIC(E) or just FIC(E)), LSA Emissions Control (Entity) (LSA EC(E) or just EC(E)), LSA Foreign Emissions Control (Entity) (LSA FEC(E) or just FEC(E)), LSA Neighboring Emissions Control (Entity) (LSA NEC(E) or just NEC(E)).

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

1. A shared access interference mitigation entity apparatus for managing interference in a wireless network, the apparatus comprising processing circuitry arranged to:
receive interference information from wireless network equipment operative within the wireless network;
receive shared access repository information on available shared access spectrum resources; and
allocate shared access spectrum resources for use in inter cell interference mitigation to the wireless network equipment dependent upon the received interference information.

2. The apparatus of claim 1, wherein the wireless network equipment comprises an enhanced Node B (eNB) or User Equipment (UE).

3. The apparatus of claim 1, wherein the apparatus is further configured to access a shared access repository information directly or via a shared access controller.

4. The apparatus of claim 1, wherein the shared access repository information includes information of shared access spectrum resources available in a pre-determined geographic area and over a pre-determined period of time, and wherein allocation of shared access spectrum resources is dependent on the shared access repository information.

5. The apparatus of claim 1, wherein to receive shared access repository information on available shared access spectrum resources comprises to receive observations from the wireless network equipment on interference events based upon measurements carried out by the wireless network equipment.

6. The apparatus of claim 1, wherein the apparatus is further arranged to re-allocate shared access spectrum resources dependent upon one or more further subsequently received interference information from wireless network equipment.

7. The apparatus of claim 1, wherein the apparatus is further arranged to instigate hand-off of a portion of the wireless network equipment to another spectrum resource.

8. The apparatus of claim 7, wherein the another spectrum resource is either a different shared access spectrum resource portion or a non-shared access spectrum resource.

9. The apparatus of claim 1, wherein the shared access interference mitigation entity is arranged to manage interference for a single network operator and/or single geographic area having a single shared access repository.

10. The apparatus of claim 1, wherein the apparatus is further arranged to terminate shared access spectrum resources use by any portion of the wireless network.

11. The apparatus of claim 2, wherein the UE provides interference information to the shared access interference mitigation entity comprising any one or more of: Reference Signal Received Power (RSRP); Reference Signal Received Quality (RSRQ); Worst/Best Companion Indicator (W/B-CI).

12. The apparatus of claim 1, wherein the eNB provides interference information to the shared access interference mitigation entity using any one or more of: an Long Term Evolution (LTE) Downlink Relative Narrowband Transmit Power Indicator (RNTPI) sent to one or more neighbour cells; an LTE Uplink High Interference Indicator (HII) and Overload Indicator (OI); an enhanced Inter-cell interference coordination (eICIC) invoke message from an interfering cell.

13. An eNB for use in a wireless network, comprising processing circuitry arranged to:
detect interference issues occurring on any wireless link in use on the eNB;
detect which UEs operating with the eNB are capable of using Licensed Shared Access (LSA) spectrum resources;
allocate LSA spectrum resources to at least one of the UEs detected to be capable of using LSA spectrum resources to mitigate interference;
track interference changes due to the allocation of LSA spectrum resources to at least a portion of the at least one UE; and
re-allocate or terminate the allocation of LSA spectrum resources to the at least a portion of the at least one of the UEs dependent on the tracked interference changes.

14. The eNB of claim 13, wherein the eNB is further arranged to allocate eICIC to UEs not capable of using LSA spectrum resources, dependent on the tracked interference changes or allocation of LSA spectrum resources to the at least one portion of the at least one of the UEs detected to be capable of using LSA spectrum resources.

15. The eNB of claim 13, wherein the to detect interference issues or track interference changes comprises signalling interference information to or from the eNB, wherein the signalling used comprises any one or more of: an LTE Downlink Relative Narrowband Transmit Power Indicator (RNTPI) sent to one or more neighbour cells; an LTE Uplink High Interference Indicator (HII) and Overload Indicator (OI); an eICIC invoke message from an interfering cell.

16. The eNB of claim 15, wherein the signalling occurs over an X2 signalling link, between the eNB and an LSA Interference Management Entity (LSA-IME).

17. The eNB of claim 15, wherein the signalling comprises any one or more of: a request for LSA spectrum resources availability information; a request for LSA spectrum resources usage; LSA spectrum resources availability information; LSA spectrum resources usage grant; LSA spectrum resources usage termination; LSA spectrum resources usage release; information on interference being experienced by any involved wireless network equipment.

18. A UE for use in a wireless network, comprising processing circuitry arranged to:
receive a signal triggering reporting of detected interference levels occurring on any wireless link in use by the UE;
send a report on the detected interference levels occurring on any wireless link in use by the UE;
receive a signal triggering use of allocated LSA spectrum resources or eICIC resources by the UE; and
use the allocated LSA spectrum resources or eICIC resources.

19. A UE for use in a wireless network, comprising processing circuitry arranged to:
measure interference levels occurring on any wireless link in use by the UE;
report the measured interference levels to an eNB or LSA-IME;
receive an instruction to use specified LSA spectrum resources from the eNB or LSA-IME; and
follow the instruction to use specified LSA spectrum resources from the eNB or LSA-IME.

20. An eNB for use in a wireless network, comprising processing circuitry arranged to:
receive a measured interference levels report on interference occurring on any wireless link in use by a UE operating with the eNB from said UE;
report the measured interference levels to an LSA-IME;
receive an instruction to use a specified LSA spectrum resources from the LSA-IME; and
forward the instruction to a specified UE operating with the eNB.

21. The eNB of claim 20, wherein the processing circuitry is further arranged to receive and forward an instruction to re-allocate or terminate LSA spectrum resources usage by the UE.

22. The eNB of claim 20, wherein the processing circuitry is further arranged to receive and forward an instruction to use eICIC resources by the UE.
